(19) United States
(12) Patent Application Publication
(10) Pub. No.: US 2018/0143168 A1
(43) Pub. Date: May 24, 2018

(54) SYSTEMS AND METHODS FOR GENERATING A PETROLEUM MODEL OF COMPOSITION USING TWO-DIMENSIONAL GAS CHROMATOGRAPHY

(71) Applicant: ExxonMobil Research and Engineering Company, Annandale, NJ (US)

(72) Inventors: Frank Cheng-Yu Wang, Annandale, NJ (US); Changyub Paek, Bridgewater, NJ (US); Kuangnan Qian, Skillman, NJ (US); Francis X. Kelly, Skillman, NJ (US)

(21) Appl. No.: 15/723,415

(22) Filed: Oct. 3, 2017

Related U.S. Application Data
(60) Provisional application No. 62/423,860, filed on Nov. 18, 2016.

(51) Int. Cl. G01N 30/60

(52) U.S. Cl. CPC G01N 30/6034

(57) ABSTRACT

Methods to generate a model of composition for a petroleum sample can include providing a petroleum sample to a two-dimensional gas chromatograph coupled with at least one detector. The chromatograph can have first and second columns. The chromatograph can be adapted to output data for each detector representing first and second dimension retention times corresponding to the first and second columns, respectively. The data representing the first and second dimension retention times for each detector based on the petroleum sample can be obtained from the chromatograph. Molecular components of the petroleum sample can be identified based at least in part on the first and second dimension retention times for each detector. The identified molecular components of the petroleum sample can be quantified based at least in part on integrated peaks of the first and second dimension retention times for each detector to generate a model of composition of the petroleum sample.

### CROSS-REFERENCE TO RELATED APPLICATIONS

This application claims priority to U.S. Provisional Application Ser. No. 62/423,860 filed Nov. 18, 2016, which is herein incorporated by reference in its entirety.

### BACKGROUND

### Field

The present disclosed subject matter relates to systems and methods for generating a model of composition, including generating a model of composition using two-dimensional gas chromatography, for example, a model of compositions of a petroleum sample.

### Description of Related Art

Petroleum and related products can have a wide range of industrial applications, such as fuel for an internal combustion engine, lubricant for the moving parts in machinery, and oil for generation of electricity and heat. The combustion of hydrocarbon mixtures (e.g., petroleum or its refined products) can produce energy. Lubricants can reduce friction during work. To manage hydrocarbon refining and upgrading processes, it can be advantageous to simulate and/or model such processes and to understand and predict the effect with operational variable changes.

To create a model of composition, the molecular composition of a hydrocarbon mixture can be identified and quantified. For example, certain techniques for temperatures below 1000° F. can determine petroleum composition and structure under the frame work of High Detailed Hydrocarbon Analysis (HDHA). Molecules in naphtha range (e.g., for carbon numbers C4 to C12) can be measured by high resolution Gas Chromatography Paraffins, Isoparaffins, Olefins, Naphtha and Aromatics (GC-PIONA) method. Distillates can be characterized by Gas Chromatography Field Ionization High Resolution Time-of-Flight Mass Spectrometry (GC-FI-TOF MS) combined with Gas Chromatography Flame Ionization Detection (GC-FID) (e.g., for normal paraffin) and Supercritical Fluid Chromatography (SFC) (e.g. for lumps of Paraffins, Naphthenes, 1-3 Ring Aromatics). Analysis techniques for Vacuum Gas Oil can include multi-dimensional liquid chromatography (LC) separations (e.g., for Silica Gel and Ring Class) followed by low or high resolution mass spectrometry. Vacuum residue (sometimes referred to as vacuum resid) can be characterized by ultra-high resolution mass spectrometry combined with solubility and chemical separations. Additionally, various bulk property measurements can be conducted on separated fractions.

A model of composition can be developed by reconciliation of analytical information. For purpose of illustration and not limitation, co-owned U.S. Pat. No. 7,598,487, filed Nov. 14, 2006, which is incorporated by reference herein in its entirety, describes the use of GC-FI-TOF MS, SFC and GC to build a petroleum model of composition. Additionally, co-owned U.S. patent application Ser. No. 13/167,816, filed Jun. 24, 2011, published as U.S. Patent Application Publication No. 2012-0153139, which is incorporated by reference herein in its entirety, describes the use of FTICR-MS (Fourier-transform ion cyclotron resonance mass spectrometry) and chromatographic separation to determine heavy petroleum model of composition. Likewise, for example and not limitation, co-owned U.S. Pat. No. 9,176,102, filed Feb. 4, 2011, which is incorporated by reference herein in its entirety, describes the use of two-dimensional gas chromotography (2DGC or GC×GC) to perform simulated distillation. Co-owned U.S. Pat. No. 9,038,435, filed Nov. 6, 2012, which is incorporated by reference herein in its entirety, describes the use of 2DGC to determine C to H ratio. Co-owned U.S. Pat. No. 9,417,220, filed Oct. 23, 2103, which is incorporated by reference herein in its entirety, describes the parallel analysis of petroleum or other hydrocarbon samples using GC-field ionization Time of Flight Mass Spectrometry (GC-FI-TOF MS) and two dimensional gas chromatography (2DGC) equipped with a flame ionization detector (2DGC FID) for improved characterization of compounds.)

However, there is no single technique or method to separate and quantify the components of a complex hydrocarbon mixture in a timely and efficient manner. As such, there remains a need for more efficient techniques to separate and quantitate a complex hydrocarbon mixture to create a model of composition for such hydrocarbon mixture.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method to generate a model of composition for a petroleum sample is disclosed. The method includes providing a petroleum sample to a two-dimensional gas chromatograph coupled to at least one detector. The two-dimensional gas chromatograph can have a first column and a second column. The method includes providing a petroleum sample to a two-dimensional gas chromatograph coupled with at least one detector. The two-dimensional gas chromatograph has a first column and a second column for analyzing the petroleum sample. The at least one detector is adapted to output data representing a first dimension retention time for one or more molecular components of the petroleum sample detected in the first column and data representing a second dimension retention time for one or more molecular components of the petroleum sample detected in the second column. It is contemplated that the first dimension retention time corresponds to at least one of a size or a boiling point of the molecular components of the petroleum sample. It is contemplated that the second dimension retention time corresponds to the polarity of the molecular components of the petroleum sample.

The method further includes obtaining from each detector the data representing the first dimension retention time for the molecular components of the petroleum sample detected in the first column and the data representing a second dimension retention time for the molecular components of the petroleum sample detected in the second column. The method further includes identifying molecular components of the petroleum sample based at least in part on the data for the first dimension retention time and the second dimension retention time for each detector, and quantifying the identified molecular components of the petroleum sample based at least in part on integrated peaks of the first dimension retention time and the second dimension retention time for each detector to generate a model of composition of the petroleum sample.

Additionally, the method includes determining at least one estimated bulk property of the petroleum sample based at least in part on the model of composition of the petroleum sample. The at least one estimated bulk property may include at least one of an estimated distillation yield and distribution, an estimated carbon-hydrogen-sulfur-nitrogen-oxygen (CHSNO) content, or an estimated American Petroleum Institute (API) gravity, and wherein the at least one measured bulk property comprises at least one of a measured distillation yield and distribution, a measured carbon-hydrogen-sulfur-nitrogen-oxygen (CHSNO) content, or a measured American Petroleum Institute (API) gravity.

The method further includes measuring at least one measured bulk property of the petroleum sample, and reconciling the model of composition of the petroleum sample based at least in part on a comparison of the at least one estimated bulk property and the at least one measured bulk property.

The method may further include creating a template based on the molecular components of model of composition of the petroleum sample. The method may further include creating additional models of compositions for additional petroleum samples by providing a second petroleum sample to the two-dimensional gas chromatograph and obtaining from each of the at least one detector the data representing the first dimension retention time for one or more molecular components of the second petroleum sample detected in the first column and the data representing a second dimension retention time for one or more molecular components of the second petroleum sample detected in the second column. The method additionally includes identifying molecular components of the second petroleum sample based at least in part on the template, the data for the first dimension retention time for each detector, and data for the second dimension retention time for each detector, and quantifying the identified molecular components of the second petroleum sample based at least in part on the template and integrated peaks of the first dimension retention time and the second dimension retention time for each detector to generate a second model of composition of the second petroleum sample. It is contemplated that the above described methodology may be repeated with additional petroleum samples to create additional models of composition corresponding to the additional samples.

In accordance with another aspect of the present invention, a system to generate a model of composition for a petroleum sample is also disclosed. The system includes a two-dimensional gas chromatograph. The two-dimensional gas chromatograph has a first column and a second column for analyzing a petroleum sample.

The system further includes at least one detector coupled to the two-dimensional gas chromatograph. The at least one detector is adapted to output data representing a first dimension retention time for one or more molecular components of the petroleum sample detected in the first column, and data representing a second dimension retention time for one or more molecular components of the petroleum sample detected in the second column. For purpose of illustration and not limitation, the at least one detector may be at least one of a mass spectrometer (MS), a flame ionization detector (FID), a sulfur chemiluminescence detector (SCD), nitrogen chemiluminescence detector (NCD), an atomic emission detector (AED), a flame photometric detector (FPD), an electron capture detector (ECD), or a nitrogen phosphorus detector (NPD). It is contemplated that the at least one detector comprises a plurality of detectors. The plurality of detectors may be coupled in parallel or serial to determine molecular composition and properties in a single analysis.

The system also includes an injector adapted to provide a petroleum sample to the two-dimensional gas chromatograph.

The system further includes a controller coupled to the two-dimensional gas chromatograph and the at least one detector. The controller is adapted to obtain from the at least one detector the data representing the first dimension retention time for one or more molecular components of the petroleum sample detected in the first column and the data representing the second dimension retention time for one or more molecular components of the petroleum sample detected in the second column. The controller is further adapted to identify molecular components of the petroleum sample based at least in part on the data for the first dimension retention time and the second dimension retention time for each detector, and quantify the identified molecular components of the petroleum sample based at least in part on integrated peaks of the first dimension retention time and the second dimension retention time for each detector to generate a model of composition of the petroleum sample. The controller is further adapted to determine at least one estimated bulk property of the petroleum sample based at least in part on the model of composition of the petroleum sample and to reconcile the model of composition of the petroleum sample based at least in part on a comparison of the at least one estimated bulk property and at least one measured bulk property.

It is contemplated that the controller is further adapted to create a template based on the molecular components of model of composition of the petroleum sample. The template may be used to create additional models of composition for additional petroleum sample. To accomplish this, the controller is adapted to obtain from each of the at least one detector the data representing the first dimension retention time for one or more molecular components of the additional petroleum sample detected in the first column and the data representing a second dimension retention time for one or more molecular components of the additional petroleum sample detected in the second column. The controller is adapted to identify molecular components of the additional petroleum sample based at least in part on the template, the data for the first dimension retention time for each detector, and data for the second dimension retention time for each detector and to quantify the identified molecular components of the additional petroleum sample based at least in part on the template and integrated peaks of the first dimension retention time and the second dimension retention time for each detector to generate a second model of composition of the additional petroleum sample. Additionally or alternatively, the controller can be further adapted to adjust a refinery process based at least in part on the model of composition of the petroleum sample.

It is contemplated that calibration of the first dimension and second dimension retention time may be performed via the use of model compounds so that a unique template can be applied to data obtained from multiple detectors.

It is contemplated that calibration of the first dimension and second dimension retention time may be performed via the use of model compounds so that a unique template can be applied to data obtained at different time and locations and by different people and instrumentation.

It is contemplated that signals detected by one detector (e.g. by mass spectrometry) may be normalized to that by another detector (e.g. by FID, NCD, SCD etc.) using the template approach.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative system according to an illustrative embodiment of the disclosed subject matter.

FIGS. 2A, 2B, and 2C are flow charts illustrating representative methods implemented according to an illustrative embodiment of the disclosed subject matter.

FIGS. 3A, 3B, 3C, and 3D each is an exemplary image of a graph illustrating two-dimensional gas chromatography data for a representative crude oil sample according to an illustrative embodiment of the disclosed subject matter, where FIG. 3A illustrates a typical GC×GC chromatograph of a crude oil sample, FIG. 3B illustrates the automatic component finding using a GC image program, FIG. 3C illustrates the automatic peak based area using a GC image program, and FIG. 3D illustrates the manually peak based illustration for the crude oil sample.

FIGS. 4A, 4B, and 4C each is an exemplary image of a graph illustrating two-dimensional gas chromatography data for a representative mid-distillated refinery stream sample according to an illustrative embodiment of the disclosed subject matter, where FIG. 4A illustrates a typical GC×GC chromatograph of the sample stream with an AED detector on a carbon atomic emission line, FIG. 4B illustrates a typical GC×GC chromatograph of the sample stream with an AED detector on a sulfur atomic emission line, and FIG. 4C illustrates a typical GC×GC chromatograph of the sample stream with an AED detector on a nitrogen atomic emission line.

FIG. 5 is a diagram illustrating further details of a representative computer system according to an illustrative embodiment of the disclosed subject matter

### DETAILED DESCRIPTION OF THE PREFERRED EMBODIMENT

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The systems and methods presented herein can be used for generating a model of composition. The disclosed subject matter is particularly suited for generating a model of composition of a petroleum sample using two-dimensional gas chromatography. The presently disclosed subject matter has application for both crude oil and refinery streams. In connection with the presently disclosed subject matter, the use of the term “petroleum” is intended to encompass crude oil, refinery streams and petrochemical processing streams.

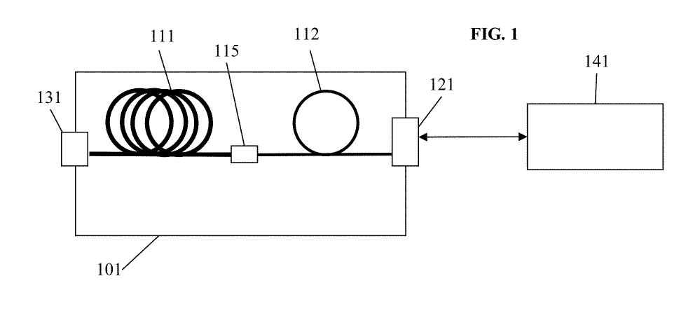

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, exemplary embodiments of systems and methods to generate a model of composition in accordance with the disclosed subject matter are shown in FIGS. 1-5. While the present disclosed subject matter is described with respect to using the systems and methods for generating a model of composition for a petroleum sample, one skilled in the art will recognize that the disclosed subject matter is not limited to the illustrative embodiment. For example, the systems, methods, and media for generating a model of composition can be used with a wide variety of settings, such as a model of composition for material samples in a lab, a manufacturing facility, a refinery, or any other suitable setting for developing a model of composition for a sample.

FIG. 1 is a diagram showing an exemplary system according to an illustrative embodiment of the disclosed subject matter to generate a model of composition of a crude oil or petroleum sample. The system 10 includes a two-dimensional gas chromatograph 101. The two-dimensional gas chromatograph 101 can have a first column 111 and a second column 112, which can be connected by a connector 115. At least one detector 121 is coupled to the two-dimensional gas chromatograph 101. The detector(s) 121 can be any suitable detector(s), including, but not limited to, at least one of a mass spectrometer (MS), a flame ionization detector (FID), a sulfur chemiluminescence detector (SCD), nitrogen chemiluminescence detector (NCD), an atomic emission detector (AED), a flame photometric detector (FPD), an electron capture detector (ECD) or a nitrogen phosphorus detector (NPD), as described herein. Each detector 121 outputs data representing a first dimension retention time for the one or more molecular components in the petroleum sample detected in the first column 111 and a second dimension retention time for the one or more molecular components in the petroleum sample detected in the second column 112.

The system 10 further includes an injector 131 adapted to provide a petroleum sample to the two-dimensional gas chromatograph 101. A controller 141 can be coupled to the two-dimensional gas chromatograph 101. The controller 141 can be any suitable controller, including, but not limited to, a desktop computer, a laptop computer, a tablet, a smartphone, a server, or any other suitable computer system, as described herein. The specific operations of the controller 141 will be described in greater detail below.

As embodied herein, the two-dimensional gas chromatograph 101 can be any suitable gas chromatograph, including, but not limited to, a commercially available Agilent 6890 gas chromatograph from Agilent Technologies®. The two-dimensional gas chromatograph 101 can be coupled to at least one detector 121. It is contemplated that more than one detector 121 is utilized and the detectors 121 operate in parallel or serial. Additionally, the two-dimensional gas chromatograph 101 can be configured with an injector 131 (e.g. a split/splitless inlet) and two columns 111, 112. The petroleum sample is injected into the two-dimensional gas chromatograph 101 via injector 131. The columns 111, 112 can include any suitable columns, including, but not limited to, a first dimensional column 111 (e.g., a BPX-5, 30 m, 0.25 mm i.d., 1.0 μm film) and a second dimensional column 112 (e.g., a BPX-50, 2 m, 0.25 mm i.d., 0.25 μm films). For example and not limitation, both columns can be commercially available columns from SGE Inc. Additionally, located between the end of the first column 111 and the beginning of the second column 112 can be a connector 115. Any suitable connector can be used, including, but not limited to, a looped jet thermal modulation assembly (e.g., commercially available from Zoex Corp.). The setup and the analysis conditions for the detectors 121 are preferably in accordance with the recommendations from the manufacturer's specifications. The data sampling rate can be 100 Hz.

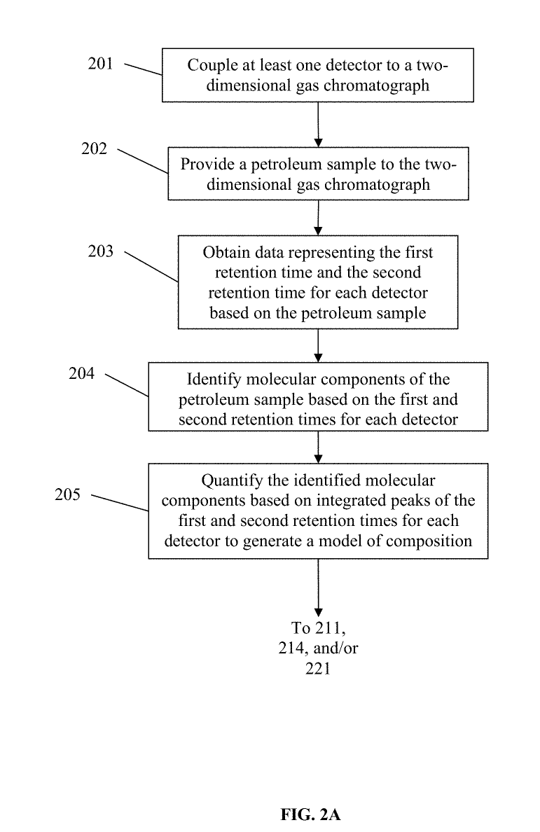

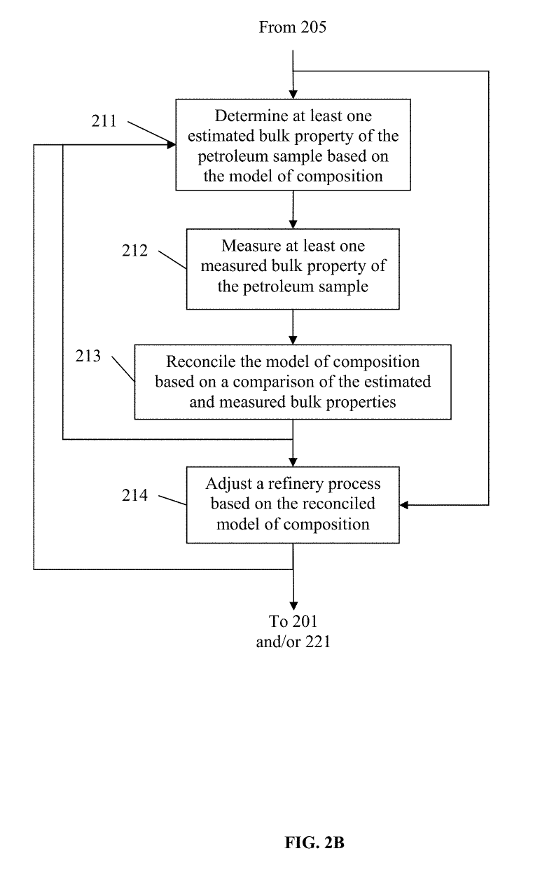

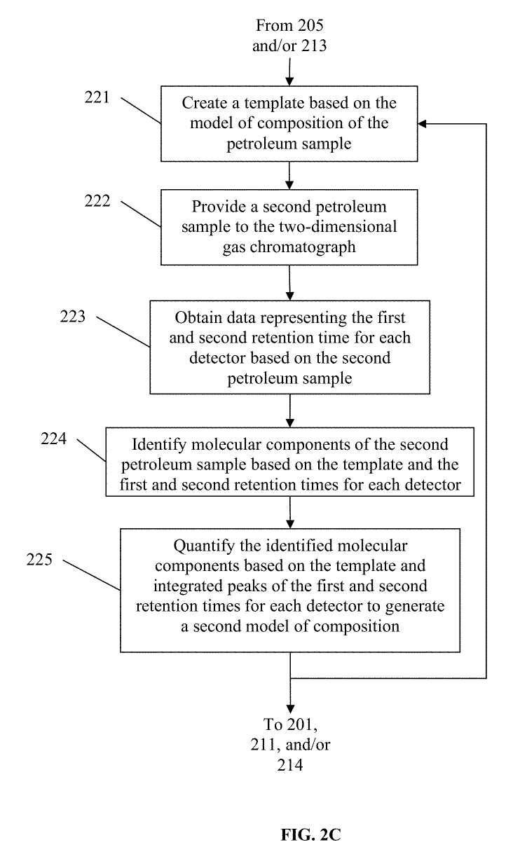

The operation of the system 10 in accordance with the presently disclosed subject matter and the methods of generating a petroleum model of composition will now be described in connection with FIGS. 2A-2C. FIGS. 2A-C are flow charts illustrating representative methods to generate a model of composition implemented according to an illustrative embodiment of the disclosed subject matter.

Referring to FIG. 2A, at 201, at least one detector 121 can be coupled to a two-dimensional gas chromatograph 101. At 202, a petroleum sample can be provided to the two-dimensional gas chromatograph 101. For example and not limitation, the petroleum sample can be provided via the injector 131. For example and not limitation, a 1.0 μL aliquot of a petroleum sample can be injected at 300° C. at a 50:1 split ratio (202). A carrier gas for the 2DGC analysis can be any suitable carrier gas, including, but not limited to, helium. The carrier gas can be provided in the constant flow mode at any suitable rate, for example, 2.0 mL/min. The oven temperature can be and suitable temperature and can be ramped up at any suitable rate, for example, ramped from 60° C. to 390° C. at a 3.0° C./min rate. The modulation period can be any suitable modulation period, for example, 10 s.

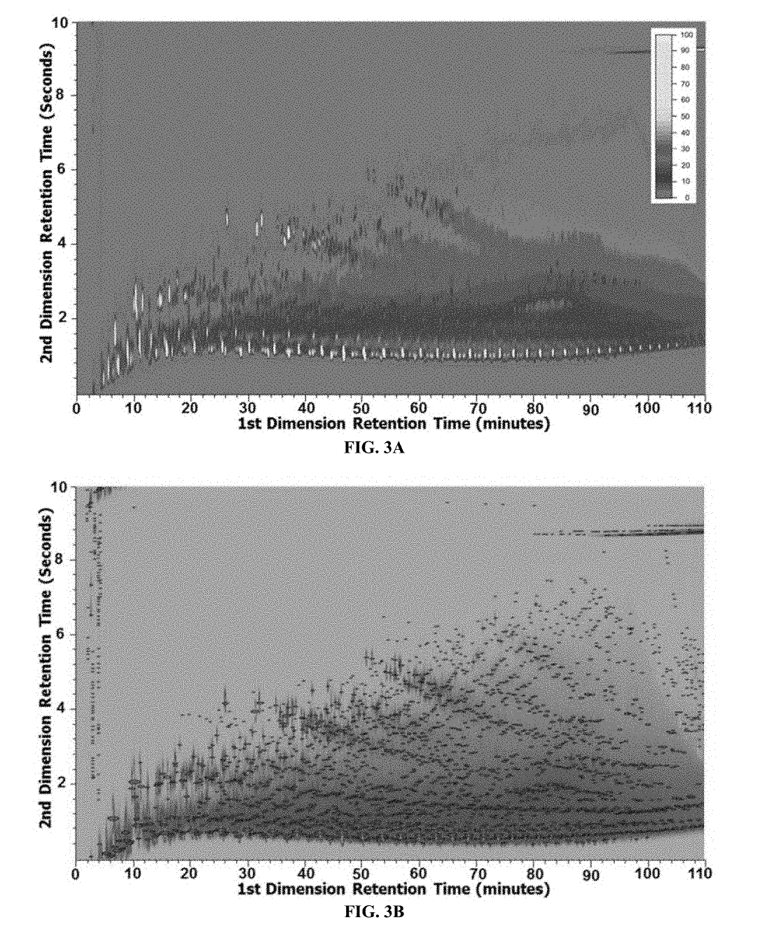

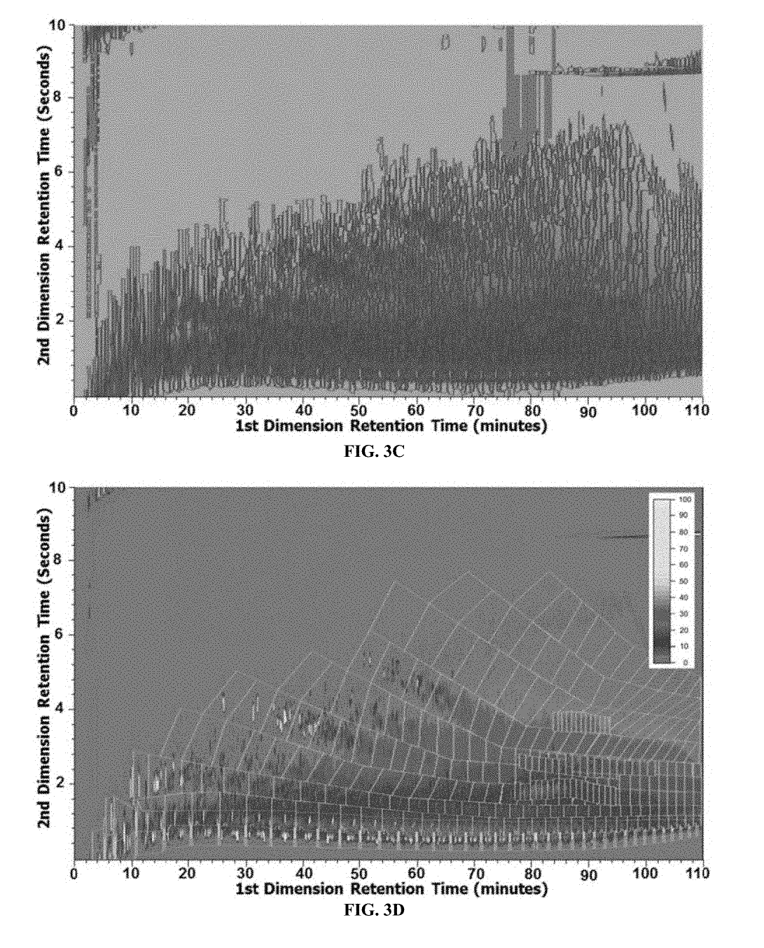

In operation, the petroleum sample is transferred to the first column 111 where data relating to the first dimension retention time for the various molecular components within the sample can be obtained. The first dimension retention time data may correspond to the size or the boiling point of the molecules, where the duration of the retention time corresponds to size of the molecular, the carbon content and boiling point. The retention time refers to the time necessary for the component to be eluted or separated from the sample within the two dimensional gas chromatograph 101 and detected by the at least one detector 121. Shorter retention times correspond to smaller molecules, lower carbon content and lower boiling points. Longer retention times correspond to larger molecules, higher carbon content and higher boiling points. In FIGS. 3A-3D, the smaller molecules are located on the left side of the graphs with respect to the Y axis. The larger molecules are located on the right side. The second dimension retention time data may correspond to the polarity of the molecules, wherein the duration of the retention times is indicative of the hydrocarbon type (e.g., alkanes, cyclic alkanes, olefins, single ring aromatics and multi-ring aromatics). Alkanes have lower retention times, while multi-ring aromatics have the longest retention times. In FIGS. 3A-3D, the alkanes are located on the lower side of the graphs with respect to the Y-axis. The multi-ring aromatics are located on the higher side of the graph with respect to the Y-axis. As embodied herein, at 203, the data representing the first dimension retention time and the second dimension retention time for each detector 121 based on the petroleum sample can be obtained from the two-dimensional gas chromatograph 101. As embodied herein, the controller 141 can be adapted to obtain the data from the two-dimensional gas chromatograph 101 and the at least one detector 121.

The controller 141 can obtain the data using any suitable technique. For example and not limitation, the data can be obtained using Chemstation (commercially available software from Agilent Technology Inc.). The data obtained can be processed as described herein to identify and quantify the components of the sample. For purpose of illustration and not limitation, comprehensive two dimensional gas chromatography (2DGC or GC×GC) can be applied to identify and quantify a single compound and/or a group of compounds and/or each of the compounds in the representative crude oil sample simultaneously.

Furthermore, and as embodied herein, at 204, molecular components of the petroleum sample can be identified based at least in part on the first dimension retention time and the second dimension retention time for each detector 121. As embodied herein, the controller 141 can be adapted to identify the components.

For purpose of illustration and not limitation, to identify the components, the data can be converted to a two-dimensional image using any suitable technique. For example and not limitation, the data can be processed using any suitable software as modified for the intended purpose, including, but not limited to, Transform (commercially available from Research Systems Inc.).

For example and not limitation, FIGS. 3A-D each depict an exemplary image generated in accordance with the disclosed subject matter. Each graph illustrates two-dimensional gas chromatography data for a representative crude oil sample for use with the system of FIG. 1 and/or the method of FIGS. 2A-C according to an illustrative embodiment of the disclosed subject matter. For example, FIG. 3A shows an exemplary 2DGC chromatogram of the representative crude oil sample. Data corresponding to the first dimension retention time can be plotted along the X-axis, and data corresponding to the second dimension retention time can be plotted along the Y-axis. As embodied herein, the first dimension retention time can correspond to at least one of a size or a boiling point of the molecular components of the petroleum sample, and the second dimension retention time can correspond to the polarity of the molecular components of the petroleum sample. For example, and not limitation, the separation along X-axis can be viewed as dependent on the size (or boiling point) of molecules. Within the same compound class, a shorter retention time can correspond to a smaller the molecule, less carbon content, and a lower the boiling point. A longer retention time can correspond to a larger molecule, more carbon content, and a higher boiling point. Additionally, the separation along Y-axis can correspond to a polarity separation. For example and not limitation, saturate molecules (e.g., normal paraffin and isoparaffin) can have low polarity and a short retention time. Multiple ring aromatic molecules can have higher polarity and a longer retention time. A reversed 2DGC configuration can also be employed to separate the components of the sample.

For purpose of illustration and not limitation, the components of the crude oil separated by 2DGC can be identified by the corresponding mass spectrum for each component. Accordingly, the aforementioned steps can be performed with a mass spectrometer attached as a detector 121. Additionally or alternatively, certain components in the lower boiling range (e.g. having a carbon number less than C25) can be identified by running model compounds or mixtures of model compounds. Additionally or alternatively, the components separated can also be identified by previous knowledge and experience, including, but not limited to, HDHA analysis and chromatographic patterns associated with homologous series. The locating of separated components can be performed manually or can be done automatically using any suitable technique. For example and not limitation, the separated components can be located by any suitable data processing software, such as GC-Image (commercially available from GC Image, LLC). For illustration, FIG. 3B shows the automatic locating of separated components by GC-Image program.

Referring again to FIG. 2A, at 205, the identified molecular components of the petroleum sample can be quantified based at least in part on integrated peaks of the first dimension retention time and the second dimension retention time for each detector to assist with the generation of a model of composition of the petroleum sample. The identified molecular components and quantities are used to establish a petroleum composition that is utilized to develop the model of composition.

For purpose of illustration and not limitation, quantitative analysis of components separated can be accomplished by integrating the peak volume in the chromatogram. The peak based area drawing can be generated using any suitable technique, including, but not limited to, manually drawing or automatically drawing by suitable data processing software, such as GC-Image. Additionally or alternatively, quantitative analysis can be accomplished using the techniques set out in co-owned U.S. Pat. No. 7,641,786, filed Sep. 25, 2007, and/or co-owned U.S. Pat. No. 7,642,095, filed Sep. 25, 2007, each of which is incorporated by reference herein in its entirety. FIG. 3C shows an exemplary automatically created peak-based area drawing by the GC-Image program. FIG. 3D shows an exemplary manually created peak-based area drawing.

For example and not limitation, Tables 1A and 1B below include the results of quantitative analysis for the representative crude oil sample. The molecules can be grouped, for example, based on the compound classes and carbon numbers. The level of detail of the model can be adjusted as needed or desired. For example, the model of the components can represent each molecule. Additionally or alternatively, the model can be configured to group isomers based on the carbon number and compound class. Each row represents a different hydrocarbon type. The bottom row represents the total weight percent of each compound class present in the sample.

TABLE 1A
Results of Quantitative Analysis

| Crude Oil | nP | isoP | N | 2N | 3N | 4N | 5N | 6N |
|---|---|---|---|---|---|---|---|---|
| 6 | | | | | | | | |
| 7 | 0.27% | 0.09% | 0.07% | | | | | |
| 8 | 0.47% | 0.29% | 0.13% | | | | | |
| 9 | 0.50% | 0.67% | 0.63% | | | | | |
| 10 | 0.57% | 0.64% | 1.00% | 0.17% | | | | |
| 11 | 0.55% | 0.62% | 0.74% | 0.31% | | | | |
| 12 | 0.54% | 0.58% | 0.69% | 0.45% | | | | |
| 13 | 0.54% | 0.71% | 0.81% | 0.53% | | | | |
| 14 | 0.54% | 0.68% | 0.84% | 0.48% | | | | |
| 15 | 0.50% | 0.62% | 0.88% | 0.40% | | | | |
| 16 | 0.44% | 0.55% | 0.80% | 0.34% | | | | |
| 17 | 0.72% | 0.66% | 0.82% | 0.29% | | | | |
| 18 | 0.53% | 0.54% | 0.84% | 0.27% | | | | |
| 19 | 0.24% | 0.60% | 0.79% | 0.30% | | | | |
| 20 | 0.41% | 0.66% | 0.80% | 0.29% | | | | |
| 21 | 0.44% | 0.45% | 0.68% | 0.23% | | | | |
| 22 | 0.44% | 0.42% | 0.60% | 0.19% | 0.17% | 0.08% | | |
| 23 | 0.44% | 0.42% | 0.61% | 0.17% | 0.15% | 0.09% | | |
| 24 | 0.44% | 0.37% | 0.52% | 0.11% | 0.18% | 0.09% | | |
| 25 | 0.40% | 0.37% | 0.51% | 0.12% | 0.23% | 0.10% | | |
| 26 | 0.38% | 0.35% | 0.47% | 0.11% | 0.23% | 0.10% | 0.04% | |
| 27 | 0.30% | 0.31% | 0.42% | 0.08% | 0.22% | 0.11% | 0.04% | |
| 28 | 0.25% | 0.30% | 0.40% | 0.09% | 0.22% | 0.10% | 0.04% | |
| 29 | 0.25% | 0.28% | 0.36% | 0.08% | 0.22% | 0.07% | 0.09% | |
| 30 | 0.18% | 0.26% | 0.33% | 0.07% | 0.18% | 0.04% | 0.15% | |
| 31 | 0.08% | 0.24% | 0.34% | 0.07% | 0.17% | 0.03% | 0.12% | 0.05% |
| 32 | 0.12% | 0.30% | 0.29% | 0.06% | 0.15% | 0.03% | 0.13% | 0.05% |
| 33 | 0.10% | 0.21% | 0.28% | 0.07% | 0.14% | 0.03% | 0.13% | 0.06% |
| 34 | 0.06% | 0.20% | 0.23% | 0.06% | 0.14% | 0.03% | 0.10% | 0.06% |
| 35 | 0.05% | 0.20% | 0.25% | 0.07% | 0.14% | 0.03% | 0.11% | 0.06% |
| 36 | 0.03% | 0.17% | 0.20% | 0.06% | 0.14% | | 0.10% | 0.06% |
| 37 | 0.05% | 0.15% | 0.18% | 0.06% | 0.14% | | 0.10% | 0.06% |
| 38 | 0.03% | 0.12% | 0.17% | 0.06% | 0.13% | | 0.09% | 0.05% |
| 39 | 0.03% | 0.12% | 0.13% | 0.04% | 0.13% | | 0.09% | 0.05% |
| 40 | 0.03% | 0.11% | 0.11% | 0.04% | | | 0.09% | 0.05% |
| 41 | 0.04% | 0.10% | 0.09% | 0.04% | | | | 0.04% |
| 42 | 0.03% | 0.07% | 0.07% | 0.04% | | | | 0.04% |
| 43 | 0.03% | 0.07% | 0.06% | 0.08% | | | | |
| 44 | 0.02% | 0.06% | 0.05% | 0.08% | | | | |
| 45 | 0.01% | 0.05% | | | | | | |
| Total | 11.04% | 13.63% | 17.19% | 5.83% | 3.06% | 0.92% | 1.42% | 0.62% |

TABLE 1B
Results of Quantitative Analysis

| Crude Oil | mo-A | N-mo-A | di-A | N-di-A | tri-A | N-tr-A | tetr-A | N-te-A |
|---|---|---|---|---|---|---|---|---|
| 6 | | | | | | | | |
| 7 | 0.76% | | | | | | | |
| 8 | 0.49% | | | | | | | |
| 9 | 1.26% | 0.05% | | | | | | |
| 10 | 0.56% | 0.22% | 0.20% | | | | | |
| 11 | 0.46% | 0.29% | 0.64% | | | | | |
| 12 | 0.44% | 0.35% | 0.94% | 0.02% | | | | |
| 13 | 0.50% | 0.46% | 0.72% | 0.12% | | | | |
| 14 | 0.62% | 0.53% | 0.67% | 0.35% | 0.11% | | | |
| 15 | 0.60% | 0.48% | 0.55% | 0.44% | 0.39% | | | |
| 16 | 0.46% | 0.44% | 0.47% | 0.39% | 0.59% | 0.01% | | |
| 17 | 0.51% | 0.42% | 0.44% | 0.39% | 0.62% | 0.03% | 0.00% | |
| 18 | 0.45% | 0.54% | 0.84% | 0.43% | 0.46% | 0.11% | 0.03% | |
| 19 | 0.40% | 0.60% | 0.79% | 0.36% | 0.38% | 0.25% | 0.10% | 0.01% |
| 20 | 0.42% | 0.45% | 0.25% | 0.33% | 0.35% | 0.40% | 0.23% | 0.05% |
| 21 | 0.40% | 0.48% | 0.26% | 0.27% | 0.23% | 0.44% | 0.28% | 0.09% |
| 22 | 0.40% | 0.43% | 0.28% | 0.20% | 0.21% | 0.41% | 0.23% | 0.15% |
| 23 | 0.41% | 0.36% | 0.27% | 0.17% | 0.23% | 0.37% | 0.26% | 0.18% |
| 24 | 0.42% | 0.39% | 0.30% | 0.09% | 0.20% | 0.11% | 0.19% | 0.13% |
| 25 | 0.36% | 0.42% | 0.30% | 0.04% | 0.22% | 0.05% | 0.13% | 0.08% |
| 26 | 0.32% | 0.13% | 0.24% | 0.02% | 0.18% | 0.05% | 0.13% | 0.04% |
| 27 | 0.32% | 0.14% | 0.15% | 0.01% | 0.18% | 0.10% | 0.10% | 0.02% |
| 28 | 0.28% | 0.14% | 0.10% | 0.02% | 0.15% | 0.15% | 0.07% | 0.02% |
| 29 | 0.27% | 0.15% | 0.06% | 0.02% | 0.14% | 0.15% | 0.05% | 0.02% |
| 30 | 0.24% | 0.11% | 0.05% | 0.01% | 0.13% | 0.13% | 0.03% | |
| 31 | 0.24% | 0.06% | 0.07% | 0.01% | 0.14% | 0.11% | 0.02% | |
| 32 | 0.21% | 0.02% | 0.09% | 0.02% | 0.13% | 0.09% | | |
| 33 | 0.18% | 0.07% | 0.10% | 0.01% | 0.14% | 0.06% | | |
| 34 | 0.17% | 0.20% | 0.15% | 0.01% | 0.13% | 0.04% | | |
| 35 | 0.17% | 0.17% | 0.13% | 0.04% | 0.11% | | | |
| 36 | 0.15% | 0.16% | 0.13% | 0.08% | 0.07% | | | |
| 37 | 0.14% | 0.15% | 0.13% | 0.09% | | | | |
| 38 | 0.11% | 0.12% | 0.12% | 0.08% | | | | |
| 39 | 0.10% | 0.12% | 0.12% | 0.08% | | | | |
| 40 | 0.10% | 0.12% | 0.12% | 0.08% | | | | |
| 41 | 0.09% | 0.11% | 0.11% | | | | | |
| 42 | 0.09% | 0.11% | 0.11% | | | | | |
| 43 | 0.09% | | | | | | | |
| 44 | | | | | | | | |
| 45 | | | | | | | | |
| Total | 13.21% | 8.85% | 8.85% | 4.19% | 5.50% | 3.05% | 1.85% | 0.79% |

As embodied herein, the at least one detector 121 can include a plurality of detectors 121. Additionally, the plurality of detectors 121 can be coupled in parallel with the two-dimensional gas chromatograph 101. In this matter, other molecules can be identified and quantified by 2DGC analysis using an appropriate detector 121. For example and not limitation, sulfur-containing molecules, nitrogen-containing molecules, and molecules containing those or other heteroatoms can be identified and quantified by 2DGC analysis using with a SCD, a NCD, or an AED, respectively, as described herein. For example, the identification and quantitative analysis can be repeated in the same manner as with the FID data, as described herein. Accordingly, the FID, SCD, NCD, and AED detectors 121 can be used in parallel to detect hydrocarbons and heteroatoms simultaneously, e.g., by stacking the SCD, NCD, and AED over the FID. The identified molecular components and quantities are used to establish a petroleum composition that is utilized to develop the model of composition. The composition is then obtained by combining the hydrocarbon composition, the sulfur composition, nitrogen composition and other heteroatomic compositions. The total composition is then normalized to 100%.

For purpose of illustration and not limitation, the quantitative determination of each molecule in the petroleum can be based at least in part on the experimental data measured by 2DGC techniques with various detection systems. The various detection systems can be coupled in parallel in order to accomplish the measurement at the same time, as described herein. Alternatively, the detection systems can be coupled at different occasions to perform the measurements in series. As embodied herein, a mass spectrometry (MS) detector can be used for general component identification/quantification and a SCD, a NCD, and an AED can be used for specific atom (e.g. S, N, O)-containing compound identification/quantification, respectively. Additionally, identification of molecule components of petroleum samples can be aided by model compound analysis, high detailed hydrocarbon analysis and extrapolations based on the trend of chromatographic patterns and physical properties of known compounds. Furthermore, and as embodied herein, for quantitative analysis, a flame ionization detector (FID) can be used for general hydrocarbon molecule quantitation, a SCD can be used for sulfur quantitation, a NCD can be used for nitrogen quantitation, and an AED can be used for specific atom-containing compound quantitation. Additionally, as embodied herein, the 2DGC compositional data from multiple detection systems can be combined to generate a detailed model of composition (e.g., FID+MS+SCD+NCD+AED) In addition to the composition data, a number of key bulk properties, such as simulated distillation (SIMDIS); American Petroleum Institute (API) gravity; and bulk amount of carbon, hydrogen, sulfur, nitrogen, oxygen (CHSNO); and total aromatic carbon content can be estimated from the model of compositions and measured by an independent technique to serve as a target quantity, as described herein. The averaged bulk properties estimated from the model of composition as determined by 2DGC can be matched to the measured target amounts by mathematically adjusting the model of composition, which can be referred to as reconciliation, as described herein.

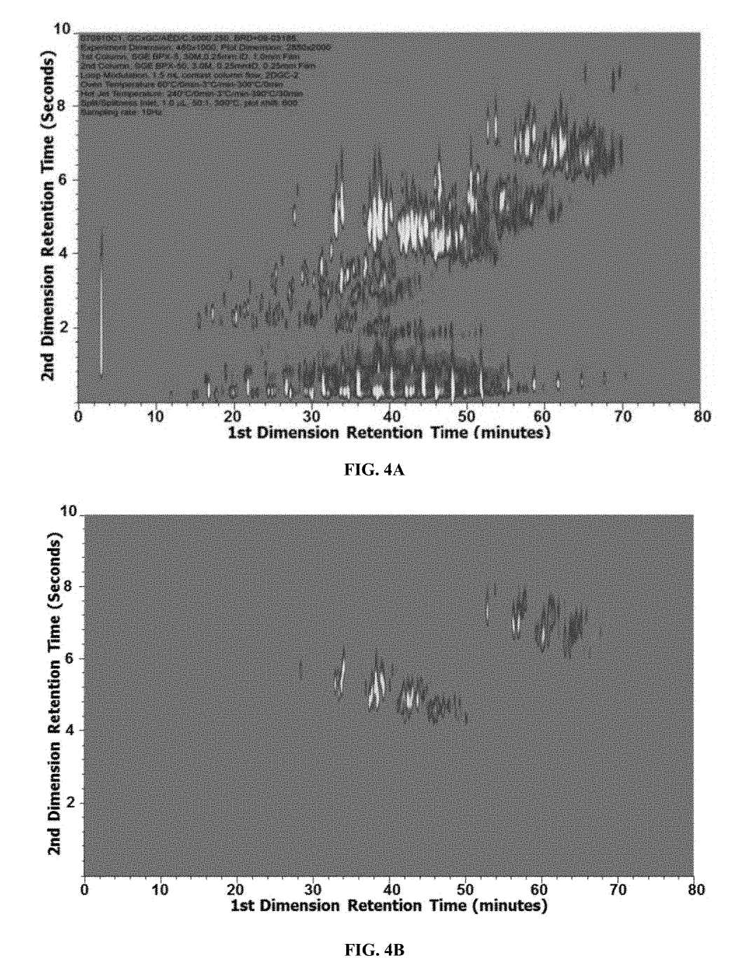

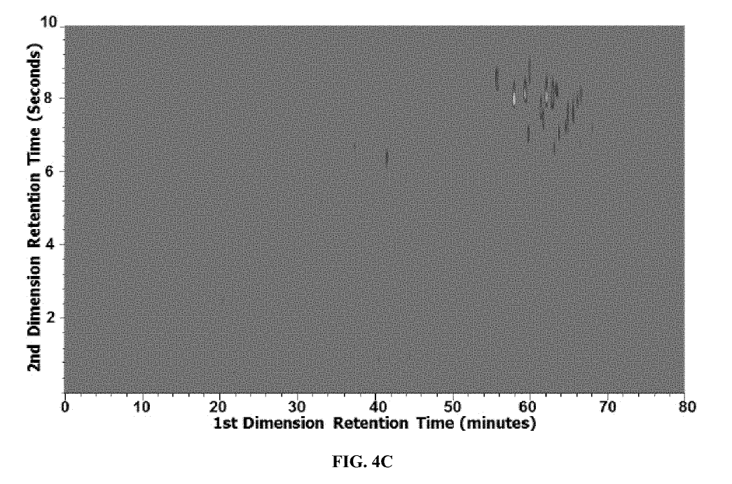

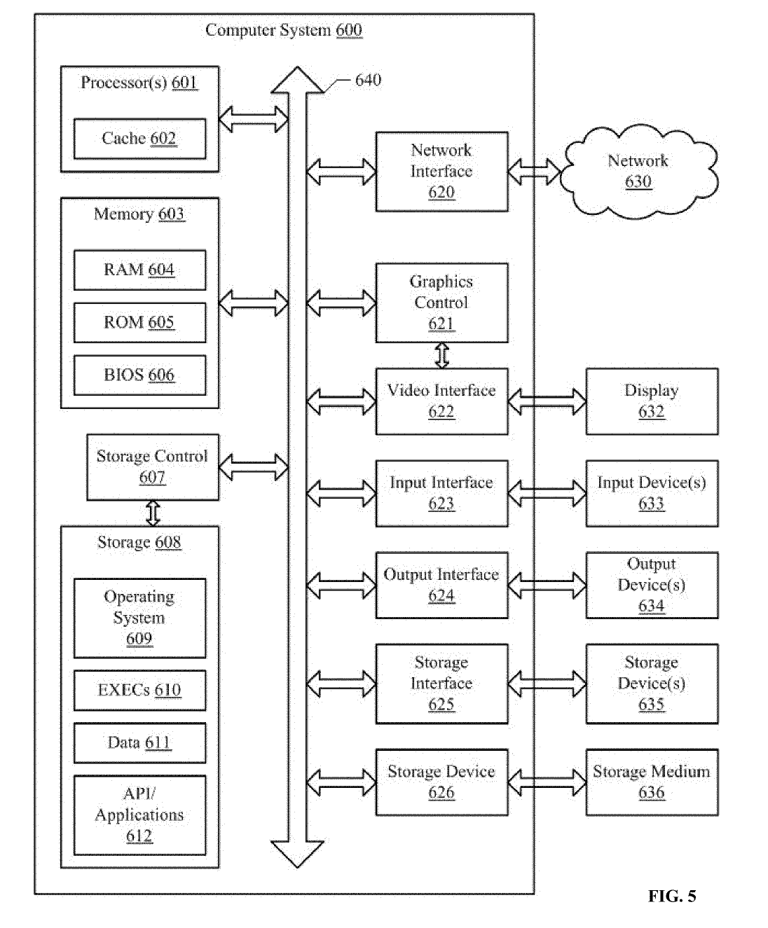

For purpose of illustration and not limitation, FIGS. 4A, 4B, and 4C each is an exemplary image of a graph generated in accordance with the disclosed subject matter. The presently disclosed subject matter has application beyond crude oil samples; rather, it is contemplated that the presently disclosed subject matter can be used to analyze and develop models of compositions for refinery and petrochemical streams. Each graph illustrates two-dimensional gas chromatography data for a representative refinery stream sample (e.g., mid-distillated refinery streams) for use with the system of FIG. 1 and/or the method of FIGS. 2A-C according to an illustrative embodiment of the disclosed subject matter. For example, FIG. 4A shows an exemplary 2DGC chromatogram of a mid-distillated refinery stream using an AED detector 121 set on the carbon atomic emission line (496 nm). For purpose of illustration and not limitation, comprehensive 2DGC can be used to demonstrate composition of a mid-distillated refinery stream. A model of composition can be generated for a single compound, for a group of compounds, and/or for all compounds in that mid-distillated refinery stream. For example and not limitation, the two dimensional gas chromatograph 101 can be an Agilent 6890 gas chromatograph configured with an injector 131 (e.g. a split/splitless inlet) and two columns 111, 112. An AED 121 can be can be coupled to the two-dimensional gas chromatograph 101. The two dimensional gas chromatograph 101 can include a first-dimensional column 111 (e.g., a BPX-5, 30 m, 0.25 mm i.d., 1.0 μm film), and a second dimensional column 112 (e.g., a BPX-50, 2 m, 0.25 mm i.d., 0.25 μm films), both of which can be commercially available from SGE Inc. The connector 115 can be a looped jet thermal modulation assembly, as described herein. The AED 121 can be any suitable AED (e.g., a commercially available AED from Joined Analytics System Inc.). The setup and the analysis conditions for the AED 121 can correspond to the recommendations from the manufacturer's specifications. For purpose of illustration, the carbon emission line (496 nm), sulfur emission line (181 nm), and the nitrogen emission line (174 nm) can be chosen for data generation. The data sampling rate can be 10 Hz.

A 1.0 μL aliquot of a mid-distillated refinery stream sample (e.g. a commercial diesel fuel sample) can be injected at 300° C. at a 25:1 split ratio. The carrier gas can be helium in the constant flow mode at 2.0 mL/min. The oven temperature can be ramped from 60° C., at 3.0° C./min increment, to 300° C. The modulation period can be 10 s. Data acquisition can be completed using Chemstation. Obtained data can be processed further to identify and quantify the components of the sample, as described herein. For identification, the data can be converted to a two-dimensional image to be processed by the Transform software. The data processing program can be used for the quantitative analysis, as described herein.

Referring to FIG. 4A, the separation along X-axis can be viewed as depending on the size of molecules, within the same compound class, as described above. The separation along Y-axis can be a polarity separation, as described above. The identified molecular components and quantities are used to establish a petroleum composition that is utilized to develop the model of composition.

Additionally, t+he detection of sulfur-containing molecules can be done in parallel or in series, as described herein. For example and not limitation, to detect sulfur, the detector 121 can be among a SCD, an AED set to the sulfur atomic emission line, or any other suitable detector which processes elemental specific detection capability such as a FPD. FIG. 4B is an exemplary 2DGC chromatogram of a representative mid-distillated refinery stream sample with the AED detector on the sulfur atomic emission line (181 nm).

Furthermore, as embodied herein, similar to detection of sulfur-containing molecules, nitrogen-containing molecules can be detected using a NCD, an AED set to the nitrogen atomic emission line, or any other suitable detector which processes elemental specific detection capability such as a NPD. FIG. 4C is an exemplary 2DGC chromatogram of a representative mid-distillated refinery stream with the AED detector on the nitrogen atomic emission line (174 nm). The composition is then obtained by combining the hydrocarbon composition, the sulfur composition, nitrogen composition and other heteroatomic compositions. The total composition is then normalized to 100%.

The obtained 2DGC data can be processed to identify and quantify the molecular components in the sample, as described herein. Additionally, the model of composition of this mid-distillate refinery stream sample can be the same as the build model of composition of the crude oil. The identified molecular components and quantities are used to establish a petroleum composition that is utilized to develop the model of composition. The composition is then obtained by combining the hydrocarbon composition, the sulfur composition, nitrogen composition and other heteroatomic compositions. The total composition is then normalized to 100%.

As embodied herein, a model of composition can be generated from the components identified and quantified based on 2DGC data from the plurality of detection systems, described above. For purpose of illustration and not limitation, the components can be combined and indexed by a unique set of numbers that are associated with a molecular structure. For example, the structure can be created in the frame work of Structural Oriented Lumping (SOL). Additionally or alternatively, the structure can be based on other structure code, such as SMILES (simplified molecular-input line-entry system). Additionally, as embodied herein, the combined components from all of the detectors can be normalized to 100%.

Referring now to FIG. 2B, at 211, at least one estimated bulk property of the petroleum sample can be determined based at least in part on the initial model of composition of the petroleum sample. For example and not limitation, the estimated bulk property can be at least one of an estimated distillation yield and distribution or, an estimated C—H—S—N—O content. The estimated API gravity is also calculated using a known composition gravity correlation. In addition to the estimation of the bulk properties and the API gravity, these properties are also determined by independent technologies. At 212, at least one measured bulk property of the petroleum sample can be measured. For example and not limitation, the measured bulk property can include at least one of a measured distillation yield and distribution, a measured C—H—S—N—O content, or a measured API gravity.

Additionally, at 213, the initial model of composition of the petroleum sample can be reconciled based at least in part on a comparison of the at least one estimated bulk property and the at least one measured bulk property. For example and not limitation, the average measured properties can be compared to corresponding estimated bulk properties derived from the 2DGC measurements to reconcile the model of composition with the measured properties, as described herein. A mathematical algorithm is applied to adjust the petroleum composition such that the bulk properties and compositions match those measured at 212. The resulting adjusted initial model of composition is the reconciled model of composition is the reconciled model of composition for the petroleum sample. Additionally or alternatively, the mathematical process for reconciliation can be the process described in U.S. Pat. No. 7,598,487 (incorporated by reference above). The reconciled model of composition can then be used as described herein.

Furthermore, and as embodied herein, at 214, a refinery process can be adjusted based at least in part on the model of composition of the petroleum sample. Additionally or alternatively, a refinery process can be adjusted based at least in part on the reconciled model of composition of the petroleum sample. For example, the model of composition of the petroleum sample can be used for real time optimization of refinery units, such as crude distillation or catalytic cracking, or for optimization of crude purchases as refinery raw materials.

Referring now to FIG. 2C, at 221, a template can be created based on the model of composition of the petroleum sample, as described above. The template may be utilized to develop models of composition for other petroleum samples. For purpose of illustration and not limitation, the model of composition from the first petroleum sample can be used as a master composition template for other petroleum samples. It is desirable to have multiple models of composition for various samples such that new samples can be quickly checked against previously created models of composition to identify the sample as a particular know crude oil or determine whether or not a new model of composition should be developed for the sample. It is contemplated that the template may be calibrated based upon measured values or properties, through the use of model compounds or other suitable means.

At 222, a second petroleum sample can be provided to the two-dimensional gas chromatograph 101, as described herein. At 223, data representing the first dimension retention time and the second dimension retention time for each detector 121 based on the second petroleum sample can be obtained from the two-dimensional gas chromatograph 101, as described above.

At 224, molecular components of the second petroleum sample can be identified based at least in part on the template and the data corresponding to the first dimension retention time and the second dimension retention time for each detector 121. For example and not limitation, if the second petroleum sample contains at least one component in common with the first petroleum sample, that component can be identified based on the template, obviating the process for identifying that component by other techniques, as described herein.

At 225, the identified molecular components of the second petroleum sample can be quantified based at least in part on the template and integrated peaks of the first dimension retention time and the second dimension retention time for each detector 121 to generate a second initial model of composition of the second petroleum sample, as described herein. For example and not limitation, if the second petroleum sample contains at least one component in common with the first petroleum sample, that component can be identified and quantified based on the template, obviating the process for identifying and quantifying that component by other techniques, as described herein. The methodology can be repeated for additional petroleum sample to develop additional models of composition.

The systems and techniques discussed herein can be implemented in a computer system. As an example and not by limitation, as shown in FIG. 5, the computer system having architecture 600 can provide functionality as a result of processor(s) 601 executing software embodied in one or more tangible, non-transitory computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface 620. The software can cause processor(s) 601 to execute particular processes or particular parts of particular processes described herein, including defining data structures stored in memory 603 and modifying such data structures according to the processes defined by the software. An exemplary input device 633 can be, for example, a keyboard, a pointing device (e.g. a mouse), a touchscreen display, a microphone and voice control interface, or the like to capture user input coupled to the input interface 623 to provide data and/or user input to the processor 601. An exemplary output device 634 can be, for example, a display (e.g. a monitor) or speakers coupled to the output interface 623 to allow the processor 601 to present a user interface, visual content, and/or audio content. Additionally or alternatively, the computer system 600 can provide an indication to the user by sending text or graphical data to a display 632 coupled to a video interface 622. Furthermore, any of the above components can provide data to or receive data from the processor 601 via a computer network 630 coupled the communication interface 620 of the computer system 600. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 601 includes hardware for executing instructions, such as those making up a computer program. As an example and not by way of limitation, to execute instructions, processor 601 can retrieve (or fetch) the instructions from an internal register, an internal cache 602, memory 603, or storage 608; decode and execute them; and then write one or more results to an internal register, an internal cache 602, memory 603, or storage 608. In particular embodiments, processor 601 can include one or more internal caches 602 for data, instructions, or addresses. This disclosure contemplates processor 601 including any suitable number of any suitable internal caches, where appropriate. As an example and not by way of limitation, processor 601 can include one or more instruction caches 602, one or more data caches 602, and one or more translation lookaside buffers (TLBs). Instructions in the instruction caches 602 can be copies of instructions in memory 603 or storage 608, and the instruction caches 602 can speed up retrieval of those instructions by processor 601. Data in the data caches 602 can be copies of data in memory 603 or storage 608 for instructions executing at processor 601 to operate on; the results of previous instructions executed at processor 601 for access by subsequent instructions executing at processor 601 or for writing to memory 603 or storage 608; or other suitable data. The data caches 602 can speed up read or write operations by processor 601. The TLBs can speed up virtual-address translation for processor 601. In some embodiments, processor 601 can include one or more internal registers for data, instructions, or addresses. This disclosure contemplates processor 601 including any suitable number of any suitable internal registers, where appropriate. Where appropriate, processor 601 can include one or more arithmetic logic units (ALUs); be a multi-core processor; or include one or more processors 601. Although this disclosure describes and illustrates a particular processor, this disclosure contemplates any suitable processor.

In some embodiments, memory 603 includes main memory for storing instructions for processor 601 to execute or data for processor 601 to operate on. As an example and not by way of limitation, computer system 600 can load instructions from storage 608 or another source (such as, for example, another computer system 600) to memory 603. Processor 601 can then load the instructions from memory 603 to an internal register or internal cache 602. To execute the instructions, processor 601 can retrieve the instructions from the internal register or internal cache 602 and decode them. During or after execution of the instructions, processor 601 can write one or more results (which can be intermediate or final results) to the internal register or internal cache 602. Processor 601 can then write one or more of those results to memory 603. In some embodiments, processor 601 executes only instructions in one or more internal registers or internal caches 602 or in memory 603 (as opposed to storage 608 or elsewhere) and operates only on data in one or more internal registers or internal caches or in memory 603 (as opposed to storage 608 or elsewhere). One or more memory buses (which can each include an address bus and a data bus) can couple processor 601 to memory 603. Bus 640 can include one or more memory buses, as described below. In particular embodiments, one or more memory management units (MMUs) reside between processor 601 and memory 603 and facilitate accesses to memory 603 requested by processor 601. In some embodiments, memory 603 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 603 can include one or more memories 604, where appropriate. Although this disclosure describes and illustrates particular memory, this disclosure contemplates any suitable memory.

In some embodiments, storage 608 includes mass storage for data or instructions. As an example and not by way of limitation, storage 608 can include a hard disk drive (HDD), a floppy disk drive, flash memory, an optical disc, a magneto-optical disc, magnetic tape, or a Universal Serial Bus (USB) drive or a combination of two or more of these. Storage 608 can include removable or non-removable (or fixed) media, where appropriate. Storage 608 can be internal or external to computer system 600, where appropriate. In some embodiments, storage 608 is non-volatile, solid-state memory. In some embodiments, storage 608 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. Storage 608 can include one or more storage control units facilitating communication between processor 601 and storage 608, where appropriate. Where appropriate, storage 608 can include one or more storages 608. Although this disclosure describes and illustrates particular storage, this disclosure contemplates any suitable storage.

In some embodiments, input interface 623 and output interface 624 can include hardware, software, or both, providing one or more interfaces for communication between computer system 600 and one or more input device(s) 633 and/or output device(s) 634. Computer system 600 can include one or more of these input device(s) 633 and/or output device(s) 634, where appropriate. One or more of these input device(s) 633 and/or output device(s) 634 can enable communication between a person and computer system 600. As an example and not by way of limitation, an input device 633 and/or output device 634 can include a keyboard, keypad, microphone, monitor, mouse, printer, scanner, speaker, still camera, stylus, tablet, touch screen, trackball, video camera, another suitable input device 633 and/or output device 634 or a combination of two or more of these. An input device 633 and/or output device 634 can include one or more sensors. This disclosure contemplates any suitable input device(s) 633 and/or output device(s) 634 and any suitable input interface 623 and output interface 624 for them. Where appropriate, input interface 623 and output interface 624 can include one or more device or software drivers enabling processor 601 to drive one or more of these input device(s) 633 and/or output device(s) 634. Input interface 623 and output interface 624 can include one or more input interfaces 623 or output interfaces 624, where appropriate. Although this disclosure describes and illustrates a particular input interface 623 and output interface 624, this disclosure contemplates any suitable input interface 623 and output interface 624.

As embodied herein, communication interface 620 can include hardware, software, or both providing one or more interfaces for communication (such as, for example, packet-based communication) between computer system 600 and one or more other computer systems 600 or one or more networks. As an example and not by way of limitation, communication interface 620 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 620 for it. As an example and not by way of limitation, computer system 600 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 600 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 can include any suitable communication interface 620 for any of these networks, where appropriate. Communication interface 620 can include one or more communication interfaces 620, where appropriate. Although this disclosure describes and illustrates a particular communication interface, this disclosure contemplates any suitable communication interface.

In some embodiments, bus 640 includes hardware, software, or both coupling components of computer system 600 to each other. As an example and not by way of limitation, bus 640 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 640 can include one or more buses 604, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

As embodied herein, this disclosed subject matter describes the use of comprehensive 2DGC and associated techniques to generate a petroleum model of composition. A detailed chemical and molecular composition, qualitative and quantitative, can be determined by 2DGC with various detection systems, as described herein. The detailed molecular composition can be reconciled with the bulk properties and average structures obtained by other analytical measurements to create a reconciled model of composition, as described herein. The model of composition can be used to assess values of petroleum samples (e.g., crude oil), to adjust refinery process, and to provide forward prediction of products properties and specifications, which can be based on the reaction mechanisms, reaction kinetics, and property-structure correlations of the petroleum.

Compared to other techniques (e.g., certain mass spectrometry, HDHA, or LC techniques), 2DGC combined with various detectors as described herein can offer advantages of simultaneous and fast identification and quantification of petroleum composition, and 2DGC can enable determination of detailed composition on a small sample without prep-scale separation, without time-consuming LC separations, and with reduced cost. Such techniques can reduce or eliminate the process of normalizing mass spectral data to chromatographically separated lumps. Such techniques can be deployed for refinery adjustment because of their relative simplicity in operations. 2DGC provides a separation technique for complex mixture analysis. It can provide improved chromatographic resolution as well as enhanced sensitivity during the separation of complex hydrocarbon mixtures. These advances using 2DGC can enable qualitative (i.e. identification) and quantitative analysis of complex hydrocarbon mixtures, as described herein. The detailed composition determined by 2DGC can be reconciled with bulk property measurements to create a self-consistent, reconciled petroleum model of composition.

### ADDITIONAL EMBODIMENTS

Additionally or alternately, the invention can include one or more of the following embodiments.

### Embodiment 1

A method to generate a model of composition for a petroleum sample, comprising: providing a petroleum sample to a two-dimensional gas chromatograph coupled with at least one detector, wherein the two-dimensional gas chromatograph having a first column and a second column for analyzing the petroleum sample, wherein the at least one detector adapted to output data representing a first dimension retention time for one or more molecular components of the petroleum sample detected in the first column and data representing a second dimension retention time for one or more molecular components of the petroleum sample detected in the second column; obtaining from each of the at least one detector the data representing the first dimension retention time for one or more molecular components of the petroleum sample detected in the first column and the data representing a second dimension retention time for one or more molecular components of the petroleum sample detected in the second column; identifying molecular components of the petroleum sample based at least in part on the data for the first dimension retention time and the second dimension retention time for each detector; quantifying the identified molecular components of the petroleum sample based at least in part on integrated peaks of the first dimension retention time and the second dimension retention time for each detector to generate a model of composition of the petroleum sample; determining at least one estimated bulk property of the petroleum sample based at least in part on the model of composition of the petroleum sample; measuring at least one measured bulk property of the petroleum sample; and reconciling the model of composition of the petroleum sample based at least in part on a comparison of the at least one estimated bulk property and the at least one measured bulk property.

### Embodiment 2

The method according to Embodiment 1, wherein the first dimension retention time corresponds to at least one of a size or a boiling point of the molecular components of the petroleum sample.

### Embodiment 3

The method according to any one of the previous Embodiments, wherein the second dimension retention time corresponds to the polarity of the molecular components of the petroleum sample.

### Embodiment 4

The method according to any one of the previous Embodiments, wherein the at least one detector is at least one of: a mass spectrometer (MS), a flame ionization detector (FID), a sulfur chemiluminescence detector (SCD), nitrogen chemiluminescence detector (NCD), an atomic emission detector (AED), a flame photometric detector (FPD), an electron capture detector (ECD) or a nitrogen phosphorus detector (NPD).

### Embodiment 5

The method according to any one of the previous Embodiments, wherein the at least one detector comprises a plurality of detectors.

### Embodiment 6

The method according to Embodiment 5, wherein the at least one detector is at least two of: a mass spectrometer (MS), a flame ionization detector (FID), a sulfur chemiluminescence detector (SCD), nitrogen chemiluminescence detector (NCD), an atomic emission detector (AED), a flame photometric detector (FPD), an electron capture detector (ECD) or a nitrogen phosphorus detector (NPD).

### Embodiment 7

The method according to Embodiment 5 or Embodiment 6, wherein the plurality of detectors are coupled in parallel.

### Embodiment 8

The method according to any one of the previous Embodiments, further comprising adjusting a refinery process based at least in part on the reconciled model of composition of the petroleum sample.

### Embodiment 9

The method according to any one of the previous Embodiments, wherein the at least one estimated bulk property comprises at least one of an estimated distillation yield and distribution, an estimated carbon-hydrogen-sulfur-nitrogen-oxygen (CHSNO) content, or an estimated American Petroleum Institute (API) gravity, and wherein the at least one measured bulk property comprises at least one of a measured distillation yield and distribution, a measured carbon-hydrogen-sulfur-nitrogen-oxygen (CHSNO) content, or a measured American Petroleum Institute (API) gravity.

### Embodiment 10

The method according to any one of the previous Embodiments, further comprising: creating a template based on the molecular components of model of composition of the petroleum sample; providing a second petroleum sample to the two-dimensional gas chromatograph; obtaining from each of the at least one detector the data representing the first dimension retention time for one or more molecular components of the second petroleum sample detected in the first column and the data representing a second dimension retention time for one or more molecular components of the second petroleum sample detected in the second column; identifying molecular components of the second petroleum sample based at least in part on the template, the data for the first dimension retention time for each detector, and data for the second dimension retention time for each detector; quantifying the identified molecular components of the second petroleum sample based at least in part on the template and integrated peaks of the first dimension retention time and the second dimension retention time for each detector to generate a second model of composition of the second petroleum sample; and generating a second model of composition of the second petroleum sample.

### Embodiment 11

The method according to Embodiment 10, wherein the first dimension retention time corresponds to at least one of a size or a boiling point of the molecular components of the second petroleum sample.

### Embodiment 12

The method according to Embodiment 10 or Embodiment 11, wherein the second dimension retention time corresponds to the polarity of the molecular components of the second petroleum sample.

### Embodiment 13

A system to generate a model of composition for a petroleum sample comprising: a two-dimensional gas chromatograph, the two-dimensional gas chromatograph having a first column and a second column, at least one detector coupled to the two-dimensional gas chromatograph, wherein the at least one detector is adapted to output data representing a first dimension retention time for one or more molecular components of the petroleum sample detected in the first column, and data representing a second dimension retention time for one or more molecular components of the petroleum sample detected in the second column; an injector adapted to provide a petroleum sample to the two-dimensional gas chromatograph; and a controller coupled to the two-dimensional gas chromatograph and adapted to: obtain from the at least one detector the data representing the first dimension retention time for one or more molecular components of the petroleum sample detected in the first column and the data representing the second dimension retention time for one or more molecular components of the petroleum sample detected in the second column; identify molecular components of the petroleum sample based at least in part on the data for the first dimension retention time and the second dimension retention time for each detector; and quantify the identified molecular components of the petroleum sample based at least in part on integrated peaks of the first dimension retention time and the second dimension retention time for each detector to generate a model of composition of the petroleum sample.

### Embodiment 14

The system according to Embodiment 13, wherein the first dimension retention time corresponds to at least one of a size or a boiling point of the molecular components of the petroleum sample.

### Embodiment 15

The system according to any one of Embodiments 13 or 14, wherein the second dimension retention time corresponds to the polarity of the molecular components of the petroleum sample.

### Embodiment 16

The system according to any one of Embodiments 13, 14 or 15, wherein the at least one detector is at least one of: a mass spectrometer (MS), a flame ionization detector (FID), a sulfur chemiluminescence detector (SCD), nitrogen chemiluminescence detector (NCD), an atomic emission detector (AED), a flame photometric detector (FPD), an electron capture detector (ECD), or a nitrogen phosphorus detector (NPD)

### Embodiment 17

The system according to any one of Embodiments 13, 14, 15, Or 16, wherein the at least one detector comprises a plurality of detectors.

### Embodiment 18

The system according to Embodiment 17, wherein the plurality of detectors are coupled in parallel.

### Embodiment 19

The system according to any one of Embodiments 13, 14, 15, 16, 17 or 18, wherein the controller is further adapted to determine at least one estimated bulk property of the petroleum sample based at least in part on the model of composition of the petroleum sample.

### Embodiment 20

The system according to Embodiment 19, wherein the controller is further adapted to reconcile the model of composition of the petroleum sample based at least in part on a comparison of the at least one estimated bulk property and at least one measured bulk property.

### Embodiment 21

The system according to any one of Embodiments 13, 14, 15, 16, 17, 18, 19 or 20, wherein the controller is further adapted to adjust a refinery process based at least in part on the reconciled model of composition of the petroleum sample.

### Embodiment 22

The system according to Embodiment 20, wherein the at least one estimated bulk property comprises at least one of an estimated distillation yield and distribution, an estimated carbon-hydrogen-sulfur-nitrogen-oxygen (CHSNO) content, or an estimated American Petroleum Institute (API) gravity, and wherein the at least one measured bulk property comprises at least one of a measured distillation yield and distribution, a measured carbon-hydrogen-sulfur-nitrogen-oxygen (CHSNO) content, or a measured American Petroleum Institute (API) gravity.

### Embodiment 23

The system according to any one of Embodiments 13 to 22, wherein the controller is further adapted to: create a template based on the molecular components of model of composition of the petroleum sample; obtain from each of the at least one detector the data representing the first dimension retention time for one or more molecular components of the second petroleum sample detected in the first column and the data representing a second dimension retention time for one or more molecular components of the second petroleum sample detected in the second column; identify molecular components of the second petroleum sample based at least in part on the template, the data for the first dimension retention time for each detector, and data for the second dimension retention time for each detector; quantify the identified molecular components of the second petroleum sample based at least in part on the template and integrated peaks of the first dimension retention time and the second dimension retention time for each detector to generate a second model of composition of the second petroleum sample; and generate a second model of composition of the second petroleum sample.

While the disclosed subject matter is described herein in terms of certain preferred embodiments, those skilled in the art will recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A method to generate a model of composition for a petroleum sample, comprising:
providing a petroleum sample to a two-dimensional gas chromatograph coupled with at least one detector, wherein the two-dimensional gas chromatograph having a first column and a second column for analyzing the petroleum sample, wherein the at least one detector adapted to output data representing a first dimension retention time for one or more molecular components of the petroleum sample detected in the first column and data representing a second dimension retention time for one or more molecular components of the petroleum sample detected in the second column;
obtaining from each of the at least one detector the data representing the first dimension retention time for one or more molecular components of the petroleum sample detected in the first column and the data representing a second dimension retention time for one or more molecular components of the petroleum sample detected in the second column;
identifying molecular components of the petroleum sample based at least in part on the data for the first dimension retention time and the second dimension retention time for each detector;
quantifying the identified molecular components of the petroleum sample based at least in part on integrated peaks of the first dimension retention time and the second dimension retention time for each detector to generate a model of composition of the petroleum sample;
determining at least one estimated bulk property of the petroleum sample based at least in part on the model of composition of the petroleum sample;
measuring at least one measured bulk property of the petroleum sample; and
reconciling the model of composition of the petroleum sample based at least in part on a comparison of the at least one estimated bulk property and the at least one measured bulk property.

2. The method of claim 1, wherein the first dimension retention time corresponds to at least one of a size or a boiling point of the molecular components of the petroleum sample.

3. The method of claim 1, wherein the second dimension retention time corresponds to the polarity of the molecular components of the petroleum sample.

4. The method of claim 1, wherein the at least one detector is at least one of: a mass spectrometer (MS), a flame ionization detector (FID), a sulfur chemiluminescence detector (SCD), nitrogen chemiluminescence detector (NCD), an atomic emission detector (AED), a flame photometric detector (FPD), an electron capture detector (ECD) or a nitrogen phosphorus detector (NPD).

5. The method of claim 1, wherein the at least one detector comprises a plurality of detectors.

6. The method of claim 5, wherein the at least one detector is at least two of: a mass spectrometer (MS), a flame ionization detector (FID), a sulfur chemiluminescence detector (SCD), nitrogen chemiluminescence detector (NCD), an atomic emission detector (AED), a flame photometric detector (FPD), an electron capture detector (ECD) or a nitrogen phosphorus detector (NPD).

7. The method of claim 5, wherein the plurality of detectors are coupled in parallel.

8. The method of claim 1, further comprising adjusting a refinery process based at least in part on the reconciled model of composition of the petroleum sample.

9. The method of claim 1, wherein the at least one estimated bulk property comprises at least one of an estimated distillation yield and distribution, an estimated carbon-hydrogen-sulfur-nitrogen-oxygen (CHSNO) content, or an estimated American Petroleum Institute (API) gravity, and wherein the at least one measured bulk property comprises at least one of a measured distillation yield and distribution, a measured carbon-hydrogen-sulfur-nitrogen-oxygen (CHSNO) content, or a measured American Petroleum Institute (API) gravity.

10. The method of claim 1, further comprising:
creating a template based on the molecular components of model of composition of the petroleum sample;
providing a second petroleum sample to the two-dimensional gas chromatograph;
obtaining from each of the at least one detector the data representing the first dimension retention time for one or more molecular components of the second petroleum sample detected in the first column and the data representing a second dimension retention time for one or more molecular components of the second petroleum sample detected in the second column;
identifying molecular components of the second petroleum sample based at least in part on the template, the data for the first dimension retention time for each detector, and data for the second dimension retention time for each detector;
quantifying the identified molecular components of the second petroleum sample based at least in part on the template and integrated peaks of the first dimension retention time and the second dimension retention time for each detector to generate a second model of composition of the second petroleum sample; and
generating a second model of composition of the second petroleum sample.

11. The method of claim 10, wherein the first dimension retention time corresponds to at least one of a size or a boiling point of the molecular components of the second petroleum sample.

12. The method of claim 10, wherein the second dimension retention time corresponds to the polarity of the molecular components of the second petroleum sample.

13. A system to generate a model of composition for a petroleum sample comprising:
a two-dimensional gas chromatograph, the two-dimensional gas chromatograph having a first column and a second column,
at least one detector coupled to the two-dimensional gas chromatograph, wherein the at least one detector is adapted to output data representing a first dimension retention time for one or more molecular components of the petroleum sample detected in the first column, and data representing a second dimension retention time for one or more molecular components of the petroleum sample detected in the second column;
an injector adapted to provide a petroleum sample to the two-dimensional gas chromatograph; and
a controller coupled to the two-dimensional gas chromatograph and adapted to:
obtain from the at least one detector the data representing the first dimension retention time for one or more molecular components of the petroleum sample detected in the first column and the data representing the second dimension retention time for one or more molecular components of the petroleum sample detected in the second column;
identify molecular components of the petroleum sample based at least in part on the data for the first dimension retention time and the second dimension retention time for each detector; and
quantify the identified molecular components of the petroleum sample based at least in part on integrated peaks of the first dimension retention time and the second dimension retention time for each detector to generate a model of composition of the petroleum sample.

14. The system of claim 13, wherein the first dimension retention time corresponds to at least one of a size or a boiling point of the molecular components of the petroleum sample.

15. The system of claim 13, wherein the second dimension retention time corresponds to the polarity of the molecular components of the petroleum sample.

16. The system of claim 13, wherein the at least one detector is at least one of: a mass spectrometer (MS), a flame ionization detector (FID), a sulfur chemiluminescence detector (SCD), nitrogen chemiluminescence detector (NCD), an atomic emission detector (AED), a flame photometric detector (FPD), an electron capture detector (ECD), or a nitrogen phosphorus detector (NPD).

17. The system of claim 13, wherein the at least one detector comprises a plurality of detectors.

18. The system of claim 17, wherein the plurality of detectors are coupled in parallel.

19. The system of claim 13, wherein the controller is further adapted to determine at least one estimated bulk property of the petroleum sample based at least in part on the model of composition of the petroleum sample.

20. The system of claim 19, wherein the controller is further adapted to reconcile the model of composition of the petroleum sample based at least in part on a comparison of the at least one estimated bulk property and at least one measured bulk property.

21. The system of claim 20, wherein the controller is further adapted to adjust a refinery process based at least in part on the reconciled model of composition of the petroleum sample.

22. The system of claim 20, wherein the at least one estimated bulk property comprises at least one of an estimated distillation yield and distribution, an estimated carbon-hydrogen-sulfur-nitrogen-oxygen (CHSNO) content, or an estimated American Petroleum Institute (API) gravity, and wherein the at least one measured bulk property comprises at least one of a measured distillation yield and distribution, a measured carbon-hydrogen-sulfur-nitrogen-oxygen (CHSNO) content, or a measured American Petroleum Institute (API) gravity.

23. The system of claim 13, wherein the controller is further adapted to:
create a template based on the molecular components of model of composition of the petroleum sample;
obtain from each of the at least one detector the data representing the first dimension retention time for one or more molecular components of the second petroleum sample detected in the first column and the data representing a second dimension retention time for one or more molecular components of the second petroleum sample detected in the second column;
identify molecular components of the second petroleum sample based at least in part on the template, the data for the first dimension retention time for each detector, and data for the second dimension retention time for each detector;
quantify the identified molecular components of the second petroleum sample based at least in part on the template and integrated peaks of the first dimension retention time and the second dimension retention time for each detector to generate a second model of composition of the second petroleum sample; and
generate a second model of composition of the second petroleum sample.
